(19) United States
(12) Patent Application Publication
(10) Pub. No.: US 2012/0209717 A1
(43) Pub. Date: Aug. 16, 2012

(54) TARGETED DELIVERY OF PAYLOAD TO MOBILE USERS

(76) Inventors: Pascal Henry, Enghien Les Bains (FR); Steven Karl Eros, Kirkland, WA (US); Kevin Hackett McGuire, Mercer Island, WA (US); Lincoln Tyler Nelson, Ottawa (CA)

(21) Appl. No.: 13/398,612

(22) Filed: Feb. 16, 2012

Related U.S. Application Data
(60) Provisional application No. 61/443,450, filed on Feb. 16, 2011.

(51) Int. Cl. G06Q 30/02

(52) U.S. Cl. 705/14.64

(57) ABSTRACT

Embodiments of the present invention enable targeted mobile payload (such as advertisement) delivery to mobile users, optimized for user experience, wireless access network characteristics and performance and advertising/marketing impact. Embodiments leverage subscriber situational insights, provided either by the wireless network or external providers, to associate with a request for advertisement (taking place while end user accesses content) a segment description and/or attributes that describe the end user. Accordingly, the advertisement industry standard (or advertiser, content-provider defined) audience to which the end user belongs can be determined in real-time, and a targeted advertisement can be delivered to the mobile end user. As such, content publisher inventory (i.e., advertisement space) can be purchased by advertisers based on audience.

### PRIORITY CLAIM

This application claims the benefit of U.S. Provisional Application Ser. No. 61/443,450 filed Feb. 16, 2011, the contents of which are incorporated herein by reference.

### FIELD OF THE INVENTION

The invention relates generally to targeted delivery of payload to mobile users.

### BACKGROUND

Conventional digital advertisement delivery is based on a supply-demand model, in which a supply side (e.g., content publisher) requests delivery of an advertisement and a demand side (e.g., advertiser) provides an advertisement in response.

Typically, in fixed Internet access networks, information regarding the user or the access device that can be obtained from the network or from the access device itself (e.g., laptop computer) is limited. Accordingly, advertisement delivery tends to be less targeted and concerned with the effects of advertisement delivery on the user experience.

Accordingly, existing advertisement delivery systems, designed for fixed Internet access networks, are not optimal for deploying advertisements to mobile devices.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a conventional digital advertisement delivery model.

FIG. 2 illustrates an example system for supporting targeted advertisement delivery to mobile devices according to an embodiment of the present invention.

FIG. 3 illustrates an example system for supporting targeted advertisement delivery to mobile devices according to an embodiment of the present invention.

FIG. 4 illustrates an example process for supporting targeted advertisement delivery to mobile devices according to an embodiment of the present invention.

FIG. 5 is a process flowchart of a method according to an embodiment of the present invention.

FIG. 6 is an example computer system useable to implement embodiments of the present invention.

The present invention will be described with reference to the accompanying drawings. Generally, the drawing in which an element first appears is typically indicated by the leftmost digit(s) in the corresponding reference number.

### DETAILED DESCRIPTION

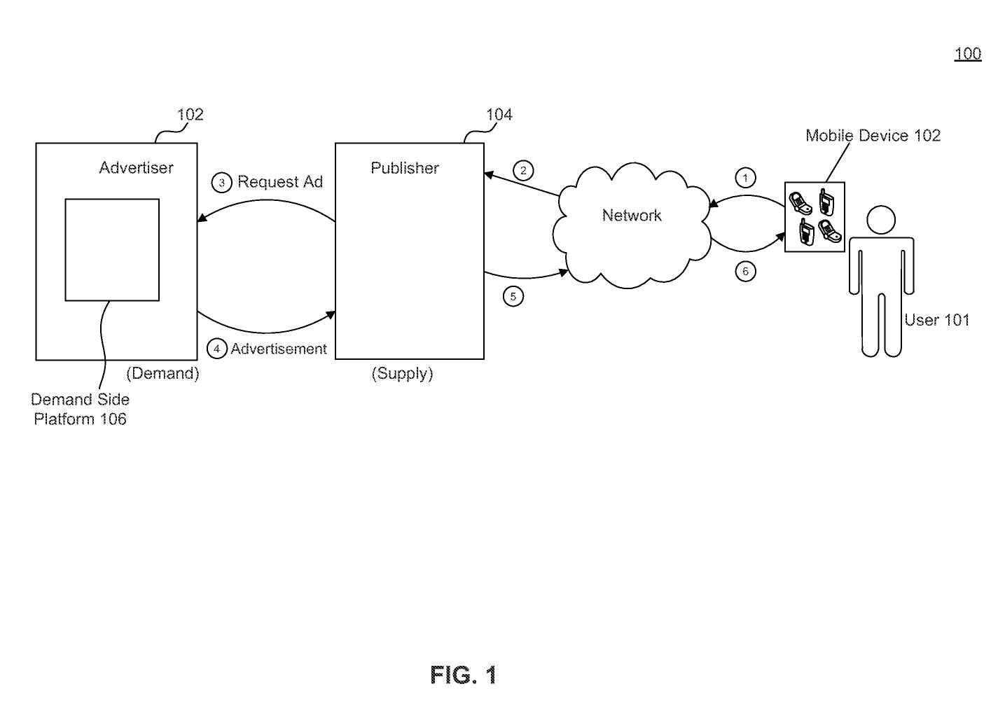

FIG. 1 illustrates a conventional digital advertisement delivery model 100. As shown in FIG. 1, model 100 is based on a supply-demand model having an advertiser 102 (demand side) and a content publisher 104 (supply side). Typically, upon receiving a request for content from an end user, publisher 104 makes a request for advertisement delivery to advertiser 102. In response, advertiser 102, which includes a demand side platform 106, sends an advertisement to publisher 104. Publisher 104 may embed the delivered advertisement in the content being provided to the end user.

In fixed Internet access networks, information regarding the end user and/or the access device (e.g., laptop computer, desktop computer, etc.) being used by the end user to access the publisher's content is minimal. Also, this information may not be obtained from the network infrastructure, for example, or otherwise. For example, in most cases, only some information, if any, may be available if the end user logs in (using a user specific account) to the content publisher's website.

The general lack of information regarding the end user, except in the case of user log-in to the content publisher's website, makes advertisement delivery in fixed Internet access networks generally not user-targeted. At the same time, lack of device information makes advertisement delivery in fixed Internet access networks non-device specific. In other words, advertisement delivery in fixed Internet access networks is not targeted to the end user (e.g., based on demographic information, location information, etc.) or optimized for the specific type of device being used by that end user to access the network.

Conventional, fixed network advertisement delivery solutions are not suitable for advertisement delivery to mobile devices, such as cellular phones, for example. Specifically, the lack of end user targeting and/or device tailoring makes conventional solutions highly intrusive and ineffective in mobile environments. Indeed, a mobile device (e.g., cellular phone, smart phone, tablet computer) is a highly personal device, which is carried on-the-go. As such, the potential impact of advertising is different on a mobile device than on a fixed access device. From a device perspective, device capabilities (e.g., screen size, operating systems, supported applications, browsers, etc.) vary greatly between mobile devices. Similarly, the QoS (Quality of Service) offered by the wireless network may vary between mobile devices, over time for a given mobile device, and between locations. For example, mobile devices may use different access network types (e.g., WiFi, GPRS, 3G, 4G, etc.), signal quality can change frequently over time, and network connectivity levels of a given carrier network vary between geographical areas.

Embodiments of the invention, as further described below, enable targeted mobile payload (e.g., advertisement) delivery to mobile users, optimized for user experience, wireless access network characteristics and performance, and advertising/marketing impact. Embodiments leverage subscriber situational insights, provided either by the wireless network or external providers, to associate with an end user request for advertisement (e.g., taking place while the end user accesses content) a segment description and/or attributes that describe the end user. Accordingly, the advertisement industry standard (or advertiser, content-provider defined) audience to which the end user belongs can be determined in real-time, and a targeted advertisement can be delivered to the mobile end user. As such, content publisher inventory (i.e., advertisement space) can be purchased by advertisers based on audience.

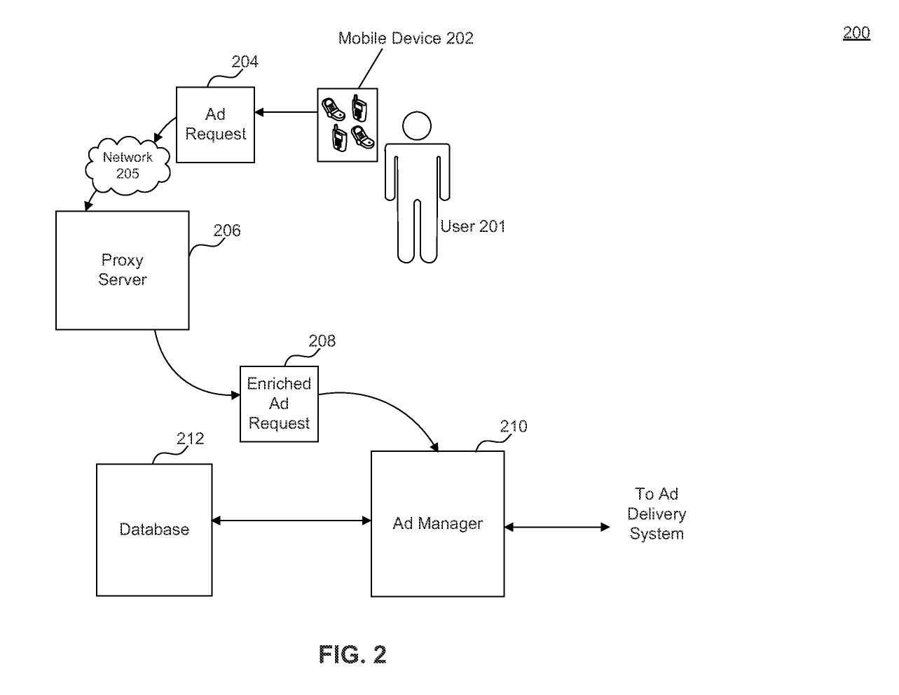

FIG. 2 is an example 200 that illustrates targeted payload delivery to mobile users according to an embodiment of the present invention. Example 200 is provided for the purpose of illustration only, and is not limiting of embodiments of the present invention. For instance, in example 200, the payload is described as an advertisement. However, as would be understood by a person of skill in the art based on the teachings herein, the payload may contain other types of information (e.g., content items including news stories, songs, ringtones, video clips, or the like, represented as text data, image data, video data, audio data) according to some embodiments.

As shown in FIG. 2, in example 200, an end user 201 uses a mobile device 202 to initiate an advertisement request 204. Advertisement request 204 may be a standalone request or embedded within a request for Internet content (e.g., an HTTP request), for example.

Request 204 is routed by wireless network infrastructure (not shown in FIG. 2) to a telecommunications proxy server (telco proxy) 206. Proxy server 206 may be part of the wireless network infrastructure and thus operated by the wireless network provider. Or, proxy server 206 may be external to the wireless network and operated by another entity. Proxy server 206 is configured and arranged to implement embodiments of the invention, as further described below. Proxy server 206 may be a conventional “off the shelf” proxy server that is modified to carry out functions and operations according to the invention. Or it may be originally configured and arranged to do so.

In one embodiment, proxy server 206 operates in a “smart” proxy mode. Accordingly, proxy server 206 enriches ad request 204 to create an enriched ad request 208. The enriched ad request 208 is enhanced with respect to ad request 204 in that it contains information about end user 201 and mobile device 202. For, example, proxy server 206 associates with request 204 a subscriber unique identifier (e.g., MSISDN—Mobile Subscriber Integrated Services Digital Network Number) that uniquely identifies mobile device 202. It provides subscriber situational insights, such as the location of the end user 201 based on, for example, cell tower location, etc. The proxy server 206 may access sources of additional data to also build into enriched advertisement request 208. In an embodiment, proxy server 206 inserts encrypted subscriber situational insights into the header portion of request 204.

In an embodiment, proxy server 206 retrieves the subscriber situational insights and/or other information from a database (not shown in FIG. 2) maintained by the wireless network provider, or by others. According to some embodiments, subscriber situational insights include end user, network and device related parameters. For example, subscriber situational insights include, without limitation, a user identification (UID), the subscriber unique identifier (MSISDN), the end user's location (can be provided at different levels of accuracies), the number of base stations tracking the end user's device, information regarding social connections (e.g., based on frequent calls, buddy list, social network connections/information, etc.), the end user's physical center of gravity (e.g., home location, work location, etc.), services subscribed/provisioned to the end user (e.g., available network bandwidth, monthly network data limits), the end user's device type and characteristics (e.g., screen size, memory size, inputs, etc.), the signal strength at the end user's device, the age of the user's device, content available on the end user's device (e.g., applications, music, pictures, video, etc.), statistics regarding application usage and external (e.g., non-mobile) services subscribed by the end user.

Enriched advertisement request 208 is routed to advertisement manager 210. As would be understood by a person of skill in the art based on the teachings herein, request 208 may be sent directly or via one of more intermediaries from proxy server 206 to advertisement manager 210. In an embodiment, advertisement manager 210 registers with a registration server of the wireless network provider in order for routing to take place through proxy server 206 to advertisement manager 210, as described above. More particularly, the registration allows a content request destined to advertisement manager 210 to be enriched by proxy server 206, as described above. According to some embodiments, various levels of request enrichment by proxy server 206 can be supported with various levels of subscriber situational insights provided by each level, allowing an advertiser, for example, to tailor the enrichment process based on subscriber situational insights that it desires to have for its advertising process.

In the “smart” proxy mode, advertisement manager 210 receives enriched advertisement request 208, decrypts the subscriber situational insights contained in the header of request 208, and then uses one or more of the subscriber situational insights from the request to associate a segment (e.g., industry or content-provider defined audience segment) and/or attributes (e.g., industry or content-provider defined attributes) with the end user of mobile device 202. In an embodiment, the segment and/or attributes are associated by lookup to a subscribers' mapping database (not shown in FIG. 2), which contains subscriber unique identifiers and their associated segment and/or attributes.

Subsequently, based on the determined user segment and/or attributes, advertisement manager 210 generates targeting parameters and/or delivery optimization parameters that are used for advertisement delivery to the user. For example, advertisement manager 210 selects the most appropriate advertisement format based on, among other parameters, the type/model of the user device and an end user score (e.g., generated using a scoring algorithm) based on the selected advertisement format. Similarly, advertisement manager 210 selects the most appropriate advertisement content based on, among other parameters, the end user's location and an end user score (e.g., generated using a scoring algorithm) based on the selected advertisement content. As would be understood by a person of skill in the art based on the teachings herein, these examples are provided for the purpose of illustration only, and are not limiting of embodiments of the present invention.

According to some embodiments, a scoring algorithm computes and incorporates parameters which reflect, one or more of user preferences, subscriber situational insights, user segment, and/or attributes to determine an end user score against a particular advertisement format or content. User preferences may be based on identified or predicted common behavior amongst users having declared similar interests or profiles. Situational insights may be based on identified or predicted common behavior amongst users having similar situational insights. Segment parameters may be based on identified or predicted common behavior amongst a group of users pertaining to the same segment. Attributes may be based on identified or predicted common behavior amongst a group of users sharing specific attributes.

Advertisement manager 210 makes available the generated targeting parameters and/or delivery optimization parameters to a demand side platform (DSP) of an advertiser. The demand side platform may be an existing DSP or a modified DSP according to some embodiments of the present invention, as further described below.

In another embodiment, proxy server 206 operates in a “thin” proxy mode. Accordingly, upon receiving request 204 from mobile device 202, proxy server 206 associates with request 204 the subscriber unique identifier and adds coded information based on the subscriber unique identifier into request 204, to generate enriched advertisement request 208.

Enriched advertisement request 208 is routed to advertisement manager 210 as described above. Advertisement manager 210 uses the coded information from request 208 to retrieve end user, network, and device related parameters from a database 212. Database 212 is provided by an external information provider, and may include one or more databases, including a subscribers' segments database, a user attributes database, and a device features database. Generally, database 212 may include similar information as provided by the subscriber situational insights, described above.

Using information obtained from database 212, advertisement manager 210 can then generate targeting parameters and/or delivery optimization parameters as described above, and provide the generated targeting parameters and/or delivery optimization parameters to a DSP of an advertiser.

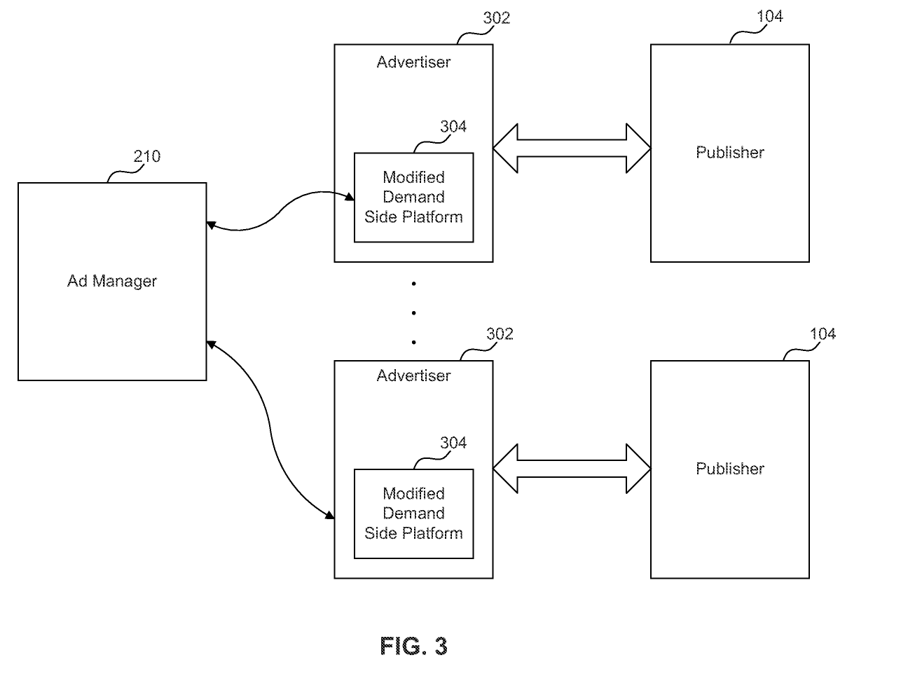

FIG. 3 is an example that illustrates targeted advertisement delivery according to an embodiment of the present invention. In particular, in FIG. 3, a plurality of advertiser modules 302, each having a modified demand side platform 304, provide targeted advertisements to a plurality of publishers 104. The modified demand side platform 304, of each advertiser module 302, is in communication with advertisement manager 210. Specifically, advertisement manager 210 communicates targeting parameters and/or delivery optimization parameters to modified demand side platform 304. Modified demand side platform incorporates the targeting parameters and/or delivery optimizations into its advertisement selection process.

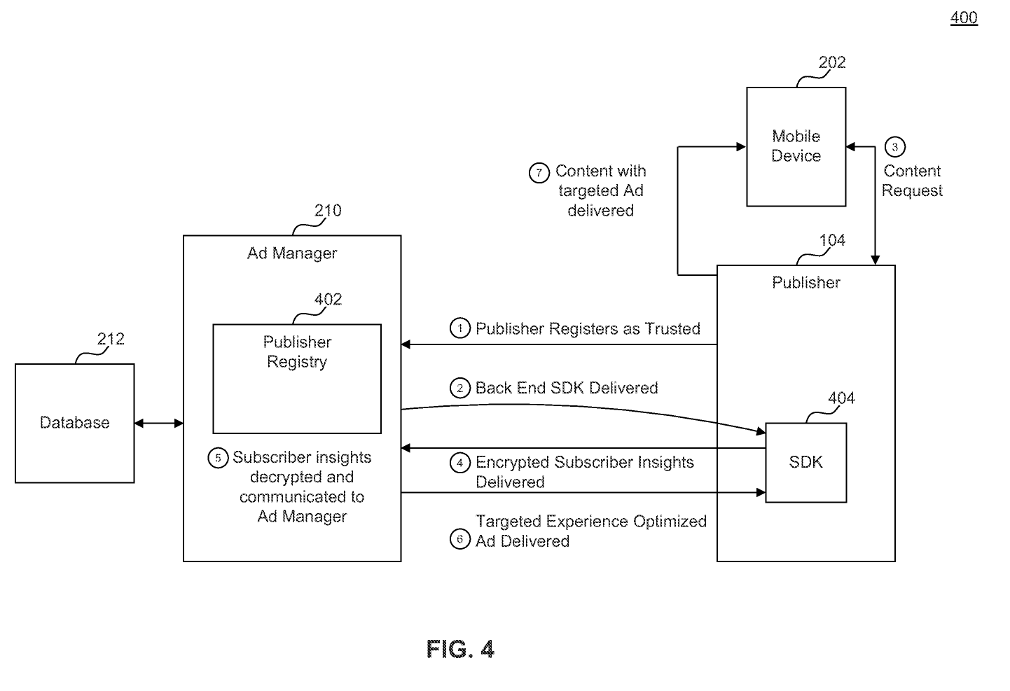

FIG. 4 illustrates an example process 400 for supporting targeted payload delivery to mobile users according to an embodiment of the present invention. Process 400 is described with reference to advertisement delivery. However, as would be understood by a person of skill in the art based on the teachings herein, embodiments are not limited to advertisement delivery and may be used to deliver other types of payloads.

Process 400 begins with publisher 104 registering as trusted with advertisement manager 210. In an embodiment, advertisement manager 210 includes a publisher registry 402 that contains a list of registered publishers. After registration, a proprietary software development kit (SDK) 404 is delivered through a back end channel (e.g., non-OTA) to publisher 104. SDK 404 is integrated within servers of publisher 104. SDK 404 may be or include or be used to generate one or more modules or interfaces that may be integrated within servers or other systems of the publisher 104. These modules or interfaces are configured to intercept and process advertisement requests as described herein.

Subsequently, mobile device 202 makes a content request to publisher 104, which also includes an advertisement request. Before reaching publisher 104, however, the advertisement request is enriched, as described above, by proxy server 206 (not shown in FIG. 4). Particularly in the “smart” proxy mode, subscriber situational insights are inserted by proxy server 206 into the header of the advertisement request.

Upon reaching publisher 104, the advertisement request is intercepted by SDK 404. SDK 404 retrieves the subscriber situational insights contained in the advertisement request and delivers the subscriber situational insights to advertisement manager 210. In an embodiment, the subscriber situational insights, which are encrypted by proxy server 206, are delivered encrypted as well by SDK 404. This ensures that the subscriber situational insights cannot be read by an authorized third party and are only decrypted by an intended advertisement manager (i.e., one registered with the registration server of the wireless network provider).

At advertisement manager 210, the delivered encrypted subscriber situational insights are examined to determine that they are received from a trusted publisher, by accessing publisher registry 402. If received from a trusted publisher, the subscriber situational insights are then decrypted and used to generate targeting parameters and/or delivery optimization parameters, as described above.

Finally, in conjunction with an existing or modified DSP (not shown in FIG. 4), a targeted and/or experience optimized advertisement is selected and delivered to SDK 404 at the publisher 104. Publisher 104 integrates the delivered advertisement into its content and delivers the content to mobile device 202.

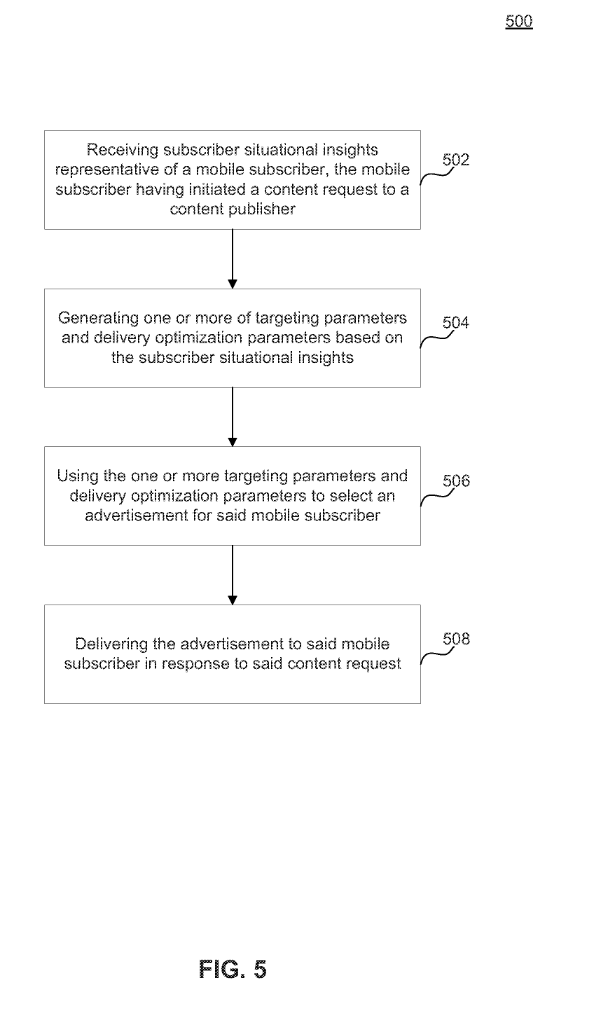

FIG. 5 illustrates an example process 500 according to an embodiment of the present invention. Process 500 is performed by an advertisement manager, such as advertisement manager 210, for example, in conjunction with an existing or modified demand side platform (DSP). Before performing process 500, the advertisement manager registers with a registration server of the wireless network. The registration establishes a registration key, for example, which can be used by the advertisement manager to decrypt certain communications as further described below.

Process 500 begins in step 502, which includes receiving subscriber situational insights representative of a mobile subscriber. In an embodiment, the subscriber situational insights are received in response to the mobile subscriber initiating a content request to a content publisher. In an embodiment, the subscriber situational insights are received from the content publisher. In particular, the content publisher extracts the subscriber situational insights from the content request, where the content request has been enriched with the subscriber situational insights by a proxy server of the wireless network before reaching the content publisher. In another embodiment, the subscriber situational insights are received from a database (e.g., data provider database) that contains subscriber situational insights regarding mobile subscribers of the wireless network. In an embodiment, the received subscriber situational insights are encrypted and may only be decrypted using the registration key established during the registration process with the registration server of the wireless network.

Step 504 includes generating one or more of targeting parameters and delivery optimization parameters based on the subscriber situational insights. In an embodiment, step 504 further includes associating one or more of an audience segment and attributes with the mobile subscriber, based on the subscriber situational insights; and generating the one or more of targeting parameters and delivery optimization parameters based on the audience segment and attributes.

Step 506 includes using the one or more targeting parameters and delivery optimization parameters to select an advertisement for the mobile subscriber. In an embodiment, step 506 is performed by an existing or modified DSP. Particularly, step 506 includes using the targeting parameters and/or delivery optimization parameters to select an advertisement optimized based on content and/or format to deliver to the mobile subscriber. Optimization based on content takes into account for example, among other parameters, the audience segment and the interests of the mobile subscriber. Optimization based on format takes into account for example, among other parameters, device characteristics of the mobile subscriber's device as well as performance of the wireless network where the mobile subscriber is currently operating.

Finally, step 508 includes delivering the selected advertisement to the mobile subscriber in response to the content request. Step 508 may be performed by an existing or modified DSP. In an embodiment, the selected advertisement is sent to the content publisher, which embeds the selected advertisement into content being sent to the mobile subscriber in response to the content request.

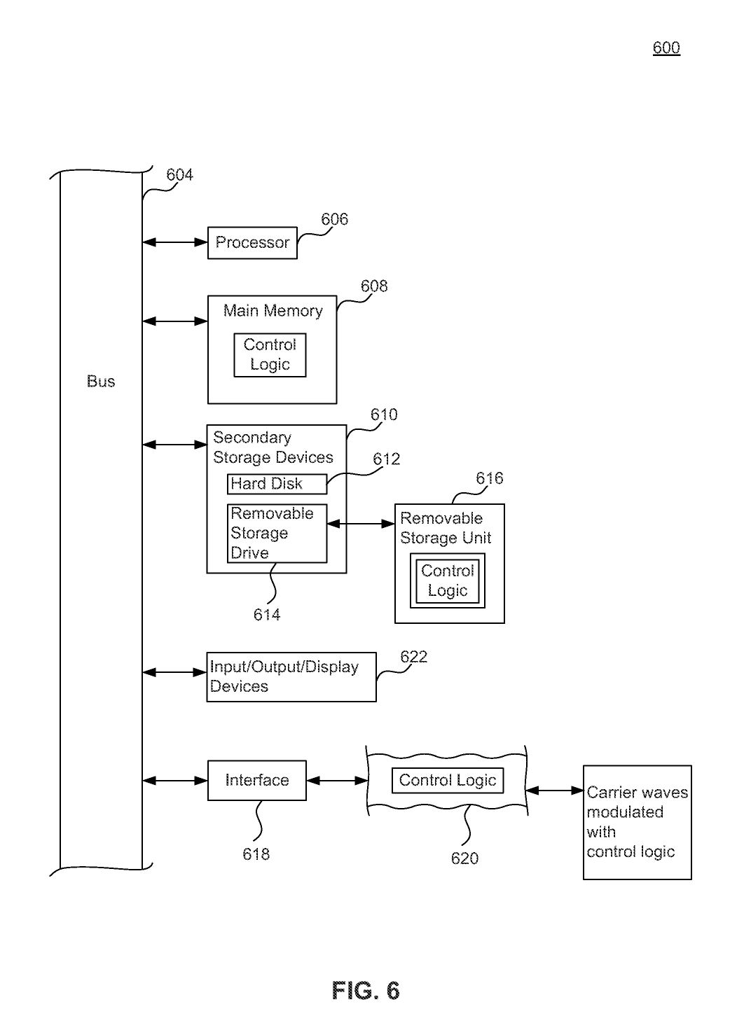

Various aspects of the invention can be implemented by software, firmware, hardware, or a combination thereof. FIG. 6 illustrates an example computer system 600 in which the present invention, or portions thereof, can be implemented as computer-readable code or instructions. After reading this description, it will become apparent to a person skilled in the relevant art how to implement the invention using other computer systems and/or computer architectures.

Computer system 600 includes one or more processors, such as processor 606. Processor 606 can be a special purpose or a general purpose processor. Processor 606 is connected to a communication infrastructure 604 (for example, a bus or network).

Computer system 600 also includes a main memory 608, preferably random access memory (RAM), and may also include a secondary memory 610. Secondary memory 610 may include, for example, a hard disk drive 612, a removable storage drive 614, and/or a memory stick. Removable storage drive 614 may comprise a floppy disk drive, a magnetic tape drive, an optical disk drive, a flash memory, or the like. The removable storage drive 614 reads from and/or writes to a removable storage unit 616 in a well-known manner. Removable storage unit 616 may comprise a floppy disk, magnetic tape, optical disk, etc. which is read by and written to by removable storage drive 614. As will be appreciated by persons skilled in the relevant art(s), removable storage unit 616 includes a computer usable storage medium having stored therein computer software and/or data.

Computer system 600 may also include a communications interface 618. Communications interface 618 allows software and data to be transferred between computer system 600 and external devices. Communications interface 618 may include a modem, a network interface (such as an Ethernet card), a communications port, a PCMCIA slot and card, or the like. Software and data transferred via communications interface 618 are in the form of signals which may be electronic, electromagnetic, optical, or other signals capable of being received by communications interface 618. These signals are provided to communications interface 618 via a communications path 620. Communications path 620 carries signals and may be implemented using wire or cable, fiber optics, a phone line, a cellular phone link, an RF link or other communications channels.

In this document, the terms “computer program medium” and “computer usable medium” and “computer readable medium” are used to generally refer to media such as removable storage drive 614, removable storage unit 616, and a hard disk installed in hard disk drive 612. Computer program medium and computer usable medium can also refer to memories, such as main memory 608 and secondary memory 610, which can be memory semiconductors (e.g. DRAMs, etc.). These computer program products are means for providing software to computer system 600. In some embodiments, computer code/instructions and/or data are stored on tangible, non-transitory computer readable media.

Computer programs (also called computer control logic or software modules) are preferably stored in main memory 608 and/or secondary memory 610. Computer programs may also be received via communications interface 618. Such computer programs, when executed, enable computer system 600 to implement the present invention as discussed herein. Accordingly, such computer programs represent controllers of the computer system 600. Where the invention is implemented using software, the software may be stored in a computer program product and loaded into computer system 600 using removable storage drive 614, interface 618, hard drive 612 or communications interface 618.

Embodiments have been described above with the aid of functional building blocks illustrating the implementation of specified functions and relationships thereof. The boundaries of these functional building blocks have been arbitrarily defined herein for the convenience of the description. Alternative boundaries can be defined so long as the specified functions and relationships thereof are appropriately performed. In addition, some embodiments may not include one or more of the illustrated modules or components and still achieve or implement the functions or techniques described herein. For example, one embodiment may not include the removable storage unit 616.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present invention should not be limited by any of the above-described exemplary embodiments, but should be defined only in accordance with the following claims and their equivalents.

1. A method comprising:
facilitating targeted advertisement delivery to mobile devices operating in a wireless network, by:
receiving subscriber situational insights representative of a mobile subscriber, the mobile subscriber having initiated a content request to a content publisher;
generating one or more of targeting parameters and delivery optimization parameters based on the subscriber situational insights;
using the one or more targeting parameters and delivery optimization parameters to select an advertisement for the mobile subscriber; and
delivering the advertisement to the mobile subscriber in response to the content request.

2. The method of claim 1, further comprising:
associating one or more of an audience segment and attributes with the mobile subscriber based on the subscriber situational insights; and
generating the one or more of targeting parameters and delivery optimization parameters based on the audience segment and attributes.

3. The method of claim 1, wherein the receiving step comprises receiving the subscriber situational insights from the content publisher, the content publisher having extracted the subscriber situational insights from the content request.

4. The method of claim 3, further comprising prior to the receiving step registering the content publisher as a trusted publisher.

5. The method of claim 3, wherein the subscriber situational insights are inserted into a header of the content request by a proxy server of the wireless network before the content publisher receives the content request.

6. The method of claim 5, wherein the subscriber situational insights are based on a subscriber unique identifier associated with the mobile subscriber.

7. The method of claim 1, wherein the receiving step comprises receiving the subscriber situation insights from a database.

8. The method of claim 1, wherein the received subscriber situational insights are encrypted, the method further comprising:
registering with a registration server of the wireless network; and
decrypting the subscriber situational insights based on a registration key established in the registering step.

9. The method of claim 1, wherein the subscriber situational insights include one or more of a user identification (UID), a subscriber unique identifier (MSISDN), location information of the mobile subscriber, information regarding social connections of the mobile subscriber, information regarding a physical center of gravity of the mobile subscriber, information regarding services subscribed/provisioned to the mobile subscriber, information regarding device type and characteristics of the mobile subscriber, information regarding signal strength at the mobile subscriber, information regarding content available on a mobile device used by the mobile subscriber, statistics regarding application usage by the mobile subscriber, and information regarding external services subscribed to by the mobile subscriber.

10. The method of claim 1, wherein the selected advertisement optimizes at least one of advertisement content and advertisement format for the mobile subscriber.

11. A computer program product comprising a computer useable hardware medium having computer program logic recorded thereon, the computer logic when executed by a processor causing the processor to perform a method comprising:
facilitating targeted advertisement delivery to mobile devices operating in a wireless network, by:
receiving subscriber situational insights representative of a mobile subscriber, the mobile subscriber having initiated a content request to a content publisher;
generating one or more of targeting parameters and delivery optimization parameters based on the subscriber situational insights;
using the one or more targeting parameters and delivery optimization parameters to select an advertisement for the mobile subscriber; and
delivering the advertisement to the mobile subscriber in response to the content request.

12. The computer program product of claim 11, wherein the method further comprises:
associating one or more of an audience segment and attributes with the mobile subscriber based on the subscriber situational insights; and
generating the one or more of targeting parameters and delivery optimization parameters based on the audience segment and attributes.

13. The computer program product of claim 11, wherein the receiving step comprises receiving the subscriber situational insights from the content publisher, the content publisher having extracted the subscriber situational insights from the content request.

14. The computer program product of claim 13, wherein the method further comprises prior to the receiving step registering the content publisher as a trusted publisher.

15. The computer program product of claim 11, wherein the receiving step comprises receiving the subscriber situation insights from a database.

16. The computer program product of claim 11, wherein the received subscriber situational insights are encrypted, the method further comprising:
registering with a registration server of the wireless network; and
decrypting the subscriber situational insights based on a registration key established in the registering step.

17. The computer program product of claim 11, wherein the selected advertisement optimizes at least one of advertisement content and advertisement format for the mobile subscriber.

18. The computer program product of claim 11, wherein the subscriber situational insights include a user identification and location information of the mobile subscriber.

19. A computer system, comprising:
a processor;
a memory; and
a module stored that is stored on the memory and that is configured, when executed by the processor, to facilitate targeted advertisement delivery to mobile devices operating in a wireless network, by:
receiving subscriber situational insights representative of a mobile subscriber, the mobile subscriber having initiated a content request to a content publisher;
generating one or more of targeting parameters and delivery optimization parameters based on the subscriber situational insights;
using the one or more targeting parameters and delivery optimization parameters to select an advertisement for the mobile subscriber; and
delivering the advertisement to the mobile subscriber in response to the content request.

20. The computer system of claim 19, further comprising a proxy server that is in communication with the wireless network and that is configured to insert the subscriber situational insights into a header of the content request before the content publisher receives the content request, wherein the subscriber situational insights include a user identifier of the mobile subscriber, location information of the mobile subscriber, and information regarding device type and characteristics of the mobile subscriber.
